(19) United States
(12) Patent Application Publication
(10) Pub. No.: US 2008/0010228 A1
(43) Pub. Date: Jan. 10, 2008

(54) Genetic algorithm and biomarker selection method for protein, peptide and vaccine

(76) Inventor: Joseph Dale Helmick, Columbus, OH (US)

Correspondence Address: JOSEPH DALE HELMICK, 5253 E. Broad St. #109, Columbus, OH, 43213, US

(21) Appl. No.: 11/481,073

(22) Filed: Jul. 5, 2006

(51) Int. Cl. G06N 3/12

(52) U.S. Cl. 706/13

(57) ABSTRACT

From an evolutionary genetic algorithm of differential selection, a computer implemented biomarker method identifies the genetic network of allele expression. The genetic algorithm comprises a biomarker selection method for identifying nucleotides, amino acids, proteins, polypeptides and vaccine applications in the medical field.

This application is new matter from prior petition application Ser. No. 09/878,811 with filing date of Jun. 10, 2001.

References Cited
U.S. Patent Documents

| | | | |
|---|---|---|---|
| 095133 | Sep. 18, 2003 | Helmick | 715/500 |

Other References
J Helmick et al, Differential Selection for RNA Evolution, The Journal of Mathematical Biology, (submitted 6/30/6) Springer, 2006.

### BACKGROUND OF THE INVENTION

### Field of the Invention

This invention presents an evolutionary genetic algorithm that comprises a computer implemented biomarker selection method for identification of protein, polypeptide and vaccine applications for medicine. The algorithm also applies to scheduling, pattern recognition, distribution economics, materials, traffic and fluid flow, and mechanical gear functions.

### SUMMARY OF THE INVENTION

A mechanism of natural selection is defined in a differential system dL/dθ=dL/dθ_{rad} dθ_{rad}/dθ° relating e, π, (2)^{1/2}, (3)^{1/2} digit positions as lengths of 1:1 correspondence with degrees mod 360 rotation of Pythagorean (π/6, π/4, π/3, π/2, 2π/3, 3π/4 . . . 2π) selection angles. Host input values expand as seed matrices that are naturally organized into deterministic segments of biochemical ensembles. Special angles function as an introverted mechanism of natural selection templates. In retroaction, introversion of the differential relation dL/dθ self-organizes symmetric and asymmetric matching selection angles into matching and non-matching digits of 1:1:1 correspondence with input digit position and template degree rotation. Biochemical and molecular design of retro-selected angles corresponds to single or double stranded RNA from relic viruses for development of proteins, polypeptides, medicinal vaccines.

### BRIEF DESCRIPTION OF THE DRAWINGS

FIG. 1 Host seed and selection angle expansions

### DETAILED DESCRIPTION OF THE INVENTION

The dL/dθ matrix represents a computational mechanism of natural selection with 16 special angles, a yod subset of 7 special angles with multiple subsets of 7-1 symmetric and asymmetric angles, and the yod null set as operators. These 3 differential selection matrices are based on the Pythagorean Theorem with constraints for the yod group and yod null set. In 1:1 correspondence with biochemical elements and properties, nucleic and amino acids, digital output is simulated in appropriate base numbering systems according to nucleotide structure or other properties. For example, binary corresponds to 2 purines, base 4 to purines and pyrimidines, octal to 8 essential amino acids, hexadecimal to 16 amino acids and octal for the 8 electrons of s and p orbital shells. Viewed as a genetic algorithm of biological evolution with nuclear shells, electron valences and functional groups, the combinations of possible conformation intermediates are large, diverse and promising especially in matching asymmetric special angles corresponding to possible optical isomers from a universal ancestor of relic viruses for antigens in vectors of potential RNA, DNA or additional vaccines.

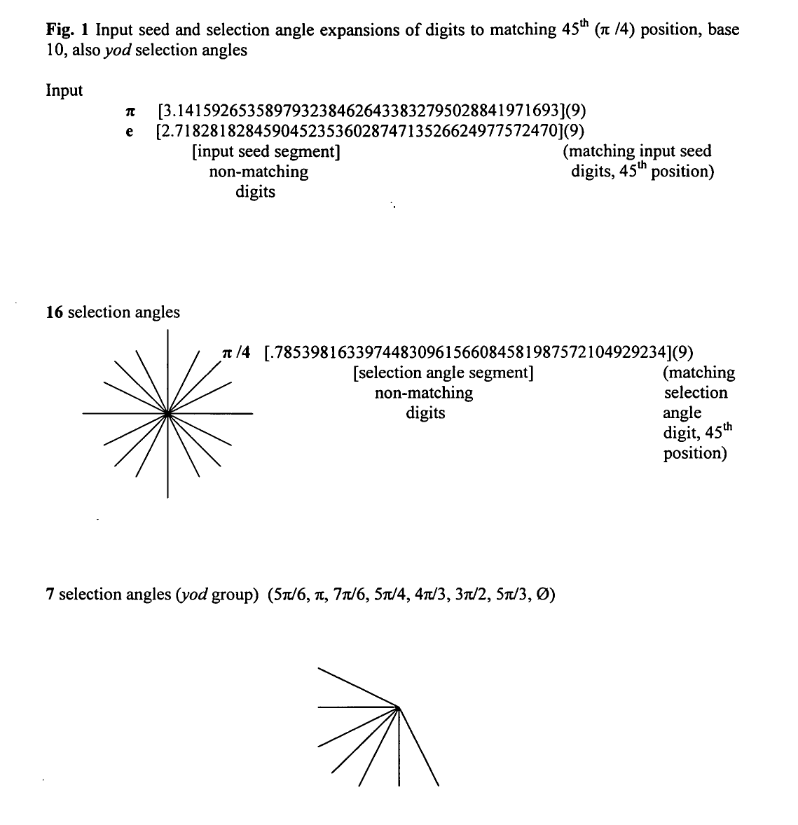

In Set Theory to Physics, for 6 combinations of 2 input values [{e ,π} {π, (2)^{1/2}} {(2)^{1/2}, (3)^{1/2}} {e, (2)^{1/2}} {π, (3)^{1/2} {e, (}3)^{1/2}}], if the digit expansions match at the same position and the position has a 1:1 correspondence to the same number of degrees mod 360 defined by a Pythagorean special angle of the natural selection matrix, input matching digits, input non-matching digits, selection angle matching digit, selection angle non-matching digits, and matching special angles are generated in data output. (FIG. 1) The 2 subsets yod and yod null are the result of constraints, −(−)=− and ±0−1=− on [dL/dθ_{rad}=dL/dθ_{rad} dθ_{rad}/dθ°]_{yod} solutions from the Pythagorean Theorem (cos θ)²+(sin θ)²=c² where the solution has a negative value under the square root. The yod group (5π/6, 7π/6 , 5π/4, 4π/3, 3π/2, 5π/3, Ø) is defined by (−)^{1/2}=yod and results from the composition of complex functions with iota.

To take dL/dθ in base 10 for example, the first matching digits from e and π input seed matrices are two 9s that occur at the 45th position of their expansions and are naturally selected by the same number of 45°, or π/4 special angle. The number of 45 units can be assigned to any scale like pico or nano provided there is consistent use. Relative to 2 matching digits by matching position and matching value from input seeds of a double strand, the third matching digit, by matching position but not necessarily by matching value, is taken from the 45th position of single or perhaps double stranded π/4, a matching special angle of natural selection. The matching digits of the input seed expansions are preceded by 88 positions of non-matching digits. The groups of non-matching digits are referred to as segments that hold distributions of digit ensembles when grouped according to the same value or nearest neighbor. The same is true of the third matching digit from π/4 matching selection angle with 44 positions of digits distributed in ensembles over the selection angle on the unit circle.

Understanding pairs of initial input values e, π, (2)^{1/2}, (3)^{1/2} and natural selection angles as predecessors [14] that give rise to families of statistical elements in deterministic segments is fundamental to nucleotide and amino acid composition from relic viruses. The progenitor seed matrices are e, π, (2)^{1/2}, (3)^{1/2} and additional infinite continued fractions may be used as well. Non-matching digits of selection angles however, appear to represent emerging mono- or di-nucleotide pre-RNA structures of viruses. By the retroaction of 1:1 matching seed digits to selection angle matching digit, a reverse enzyme may be evidenced in ribozyme catalytic polymerization of picomavirus replication.

The code of the genetic algorithm is as follows:

```
Programming Parameters & Packages
  Needs [ “Graphics ‘ Graphics’ ” ]
  Needs [ “Statistics ‘ DataManipulation ’ ” ]
  LengthofString = 1000000
Digit Representations
  d = RealDigits [ E, 10, LengthofString ] [ [1] ] ;
  c = RealDigits [ Pi, 10, LengthofString ] [ [1] ] ;
Digit Representations in Special Angles
  SpecialAngles =
    (Table [
    { 0 + 2 Pi k + 30, 0 + 2 Pi k + 30 + 15, 0 + 2 Pi k + 30 + 30, 0 + 2 Pi k + 30 + 60, 0 + 2 Pi k + 30 + 90,
    0 + 2 Pi k + 30 + 15 + 90, 0 + 2 Pi k + 30 + 30 + 90, 0 + 2 Pi k + 30 + 60 + 90, 0 + 2 Pi k + 30 + 180,
    0 + 2 Pi k + 30 + 15 + 180, 0 + 2 Pi k + 30 + 30 + 180, 0 + 2 Pi k + 30 + 60 + 180,
    0 + 2 Pi k + 30 + 270, 0 + 2 Pi k + 30 + 15 + 270, 0 + 2 Pi k + 30 + 30 + 270,
    0 + 2 Pi k + 30 + 60 + 270}, { k, 0, .95 LengthOfString / 360 } ] / / Flatten ) /. Pi → 180 ;
  cc = Part [ c, (Table [
    { 0 + 2 Pi k + 30, 0 + 2 Pi k + 30 + 15, 0 + 2 Pi k + 30 + 30, 0 + 2 Pi k + 30 + 60, 0 + 2 Pi k + 30 + 90,
    0 + 2 Pi k + 30 + 15 + 90, 0 + 2 Pi k + 30 + 30 + 90, 0 + 2 Pi k + 30 + 60 + 90, 0 + 2 Pi k + 30 + 180,
    0 + 2 Pi k + 30 + 15 + 180, 0 + 2 Pi k + 30 + 30 + 180, 0 + 2 Pi k + 30 + 60 + 180,
    0 + 2 Pi k + 30 + 270, 0 + 2 Pi k + 30 + 15 + 270, 0 + 2 Pi k + 30 + 30 + 270,
    0 + 2 Pi k + 30 + 60 + 270} , { k, 0, .95 LengthOfString / 360 } ] / / Flatten ) /. Pi → 180
    ] ;
  dd = Part [ d, (Table [
    { 0 + 2 Pi k + 30, 0 + 2 Pi k + 30 + 15, 0 + 2 Pi k + 30 + 30, 0 + 2 Pi k + 30 + 60, 0 + 2 Pi k + 30 + 90,
    0 + 2 Pi k + 30 + 15 + 90, 0 + 2 Pi k + 30 + 30 + 90, 0 + 2 Pi k + 30 + 60 + 90, 0 + 2 Pi k + 30 + 180,
    0 + 2 Pi k + 30 + 15 + 180, 0 + 2 Pi k + 30 + 30 + 180, 0 + 2 Pi k + 30 + 60 + 180,
    0 + 2 Pi k + 30 + 270, 0 + 2 Pi k + 30 + 15 + 270, 0 + 2 Pi k + 30 + 30 + 270,
    0 + 2 Pi k + 30 + 60 + 270} , { k, 0, .95 LengthOfString / 360 } ] / / Flatten ) /. Pi → 180
    ] ;
  Length [ cc ]
Special Angle Number ( 1 = Pi / 6, 2 = Pi / 4 ...) for Matching Digit Positions
  Flatten [ Position [ Table [ dd [ [ k ] ] == [ [ k ] ], { k, 1, Length [ cc ] } ] , True] ]
Matching Special Angles
  Part [
    (Table [
    { 0 + 2 Pi k + 30, 0 + 2 Pi k + 30 + 15, 0 + 2 Pi k + 30 + 30, 0 + 2 Pi k + 30 + 60, 0 + 2 Pi k + 30 + 90,
    0 + 2 Pi k + 30 + 15 + 90, 0 + 2 Pi k + 30 + 30 + 90, 0 + 2 Pi k + 30 + 60 + 90, 0 + 2 Pi k + 30 + 180,
    0 + 2 Pi k + 30 + 15 + 180, 0 + 2 Pi k + 30 + 30 + 180, 0 + 2 Pi k + 30 + 60 + 180,
    0 + 2 Pi k + 30 + 270, 0 + 2 Pi k + 30 + 15 + 270, 0 + 2 Pi k + 30 + 30 + 270,
    0 + 2 Pi k + 30 + 60 + 270} , { k, 0, .95 LengthOfString / 360 } ] / / Flatten ) /. Pi → 180 ,
  Flatten [ % ]
  ]
Matching Digit Pairs
    MatchingDigits = c [ [ % ] ]
    d [ [ %% ] ]
Frequencies [ MatchingDigits ]
Histogram [ MatchingDigits ]
Table [ ListPlot [ Transpose [ { Drop [ MatchingDigits, k ] , Drop [ MatchingDigits, − k ] } ] ] ,
  { k, 1, 100, 10} ] -
```

Additional modifications in the code are needed to output non-matching selection angle digits, matching selection angle matching digits and non-matching host seed digits.

The matching special angle of 30° or π/6 shows the maximum number of matching digits and suggests an optimum angle for cytotoxic T lymphocyte (CTL) vector targeting of epitopes expressed by allele and gene location with angular positioner and optical encoder. In the yod group however selection angles descend to 5π/4 suggesting a second optimum angle for CTL vector targeting directed against the encoded proteins in capsid shell (yod null group) of infected tissues.

Supervised classification and pattern recognition-based multivariate analysis of digit-biochemical correspondence emerge as fulcrums for subsequent applications. In addition to nearest neighbor and grouping of digit values, classification techniques of support vector machines, neural networks, linear regression, multi-layer perception and diagonal linear discriminant analysis are a few of the existing analytic tools to configure polar and rearrangement structures and equations. Once biochemical molecules and functional group nuclei take shape in characteristic structures, identification of sequencing patterns from mapping and orientation of molecular grids and template matrices point to alignment of protein-nucleic acid conjugation. Also, simulations of 8 essential amino acids in octal in parallel with 7-Ø yod selection angles may provide an interesting matrix for nucleic acid template and vaccine development.

System convergence is a good indicator of recognition emphasizing better solutions by natural selection of matching digits as biomarkers where DNA coding of the same gene is represented in its alleles. In genome-scale profiling experiments, identifying biomarkers as a tool to understand complex disease could relate host seed segments and matching digits to a selection method for biomarkers of a genetic network showing differential expression. The same reasoning is applied to the digit ensembles of selection angles. RNA enzymes or ribozymes catalyze new RNA molecules by self-splicing introns in self-replication. Length, being intrinsic to dL/dθ mechanics, is counted by linear decimal and rotational degree positions and suggests a good measure for intron self-splicing and transposon recombination locations. The introverted nature of dL/dθ is characterized by retroactive 1:1:1 matching of matching selection angle-input seed matching digits-selection angle matching digits and the distribution of non-matching digits over the matching selection angle is determined by frequency of self-similar digits grouped in ensembles. In RNA the self-catalysis of transposons that relocate exons, thus recombining genes including functional mutation, also develops RNA adaptors in the binding of amino acids using an RNA template. In 1:1 correspondence with nucleotides, biochemical elements and properties, matching digits from host seeds act as a receptor location site for a codon signaled by polarity from matching selection angle. As a coding region, the selection angle could effectively implant itself to the host seed by self-splicing recognition of matching selection angle-input seed matching digits-selection angle matching digits through signal polarity and nucleotide affinity. The selection angle now corresponding to a viral transposon with enclosed exon is relocated to the host matching digit position and self-splices therein. In dL/dθ, the natural selection angles with templates of 16, 7-1, and null with both symmetric and asymmetric matching angle matrices show the multiplicity of recombinations and possible mutations is large and diverse, but not insurmountable.

In self-replication input host seeds are the source for the natural selection of special angles to acquire, by foresight of angle polarity, host seed matching digits through matching special angles. In this case, introverted retro-selection of matching and non-matching selection angle digits suggests initiation of ribozyme catalytic polymerization similar to reverse transcriptase for transcription of picomaHIV-angle genome proliferation. The matching digits from both host seeds and polar selection angles function as host seed segments and selection angle biomarkers. The connection of host seed matching digits, selection angles and selection angle matching digits with ribozyme reverse transcriptase is a 1:1:1 design of biochemical correspondence with digit ensembles and biochemical properties.

Furthermore, picomaHIV recognizes host input seeds by angle polarity as holding a communicable signal to proliferation of its viral genome. PicomaHIV intuitively understands that without host seed contribution, transcription could not proliferate. Virus intuition based on angle polarity may explain HIV-positive cases that are not communicable in that there is no affinity by reason of polar bond repulsion. It is reasonable to conjecture that host-seed matching digits and selection angle matching digits hold a binary or base 2 polarity code. For HIV-positive cases that are communicable by polar attraction, codon affinity of functional groups could be an antigen vector technique for anti-hemagglutination of HIV receptors.

Since the HIV genome is composed of at least 7 gene types, 7 is a minimum or essential value. Coincidentally, the yod group is also composed of 7 shells and according to Table 4 holds over 600 asymmetric matching angles and their matching and non-matching digits of biochemical ensembles. Nearest neighbors of biochemical ensembles suggest element composition of functional groups and ligand recognition in complementary base pairs. The complementary nature of emerging ribonucleotides, for example in receptor-ligand binding, depends in part on stereochemical and electrostatic orientation of their functional groups. To ligate oligonucleotides on a plane or grid of complementary template by stereochemical and electrostatic orientation, bonding angles, and functional group affinities between input seed and selection angle ensembles represents a matching of base pairs. The third base pair of the triplet is wedged in from the torquing force of a mechanical ratchet action in the natural selection rotation of special angle matrices and computed for wedge product determinants and parallelepipeds. Since 1:1 matching of 2 nucleotide base pairs is required and determined by host seed ensembles, the third base pair makes sense as ratcheted and wedged in to the matching digit position of input seeds by the torquing force of selection angle ensembles.

The dL/dθ matrix represents a mechanism of natural selection with 16 special angles, a yod subset of 7 special angles with multiple subsets of 7-1 symmetric and asymmetric angles, and the yod null set as operators. These 3 differential selection matrices are based on the Pythagorean Theorem with constraints for the yod group and yod null set. In 1:1 correspondence with biochemical elements and properties, nucleic and amino acids, digital output is simulated in appropriate base numbering systems according to nucleotide structure or other properties. For example, binary corresponds to 2 purines, base 4 to purines and pyrimidines, octal to 8 essential amino acids, hexadecimal to 16 amino acids and octal for the 8 electrons of s and p orbital shells. Viewed as a genetic algorithm of biological evolution with nuclear shells, electron valences and functional groups, the combinations of possible conformation intermediates are large, diverse and promising especially in matching asymmetric special angles corresponding to possible optical isomers from a universal ancestor of relic viruses for antigens in vectors of potential RNA, DNA and additional vaccines.

I claim:

1. A computer readable memory for genetic algorithm of evolutionary design.

2. The claim of 1. for identifying a DNA subunit vaccine antibody.

3. The claim of 1. for identifying an RNA enzyme vaccine antibody.

4. The claim of 1. for identifying a ribonucleoprotein, protein and polypeptide.

5. The claim of 1. for identifying a reverse transcriptase enzyme vaccine antibody.

6. A computer implemented method for biomarker selection of genetic network with differential expression.
